(19) United States
(12) Patent Application Publication
(10) Pub. No.: US 2012/0196775 A1
(43) Pub. Date: Aug. 2, 2012

(54) EMISSION INTENSITY MEASURING DEVICE

(75) Inventor: Ayumu Taguchi, Tokyo (JP)

(73) Assignee: SONY CORPORATION, Tokyo (JP)

(21) Appl. No.: 13/326,021

(22) Filed: Dec. 14, 2011

(30) Foreign Application Priority Data
Jan. 27, 2011 (JP) 2011-014823

(51) Int. Cl. C40B 60/12

(52) U.S. Cl. 506/39

(57) ABSTRACT

An emission intensity measuring device includes a light receiving unit that is disposed opposed to a biochip having a plurality of compartments in which a sample is housed, and includes a plurality of light receiving elements that are arranged, and a determining section that determines a weighting rate of each of the light receiving elements based on a noise characteristic of the light receiving element, acquired in advance. The emission intensity measuring device further includes a multiplying section that multiplies the output of each of the light receiving elements by the weighting rate to calculate a weighted output of each of the light receiving elements, and an adding section that adds the weighted outputs of the light receiving elements opposed to a respective one of the compartments.

### CROSS REFERENCES TO RELATED APPLICATIONS

The present application claims priority to Japanese Priority Patent Application JP 2011-014823 filed in the Japan Patent Office on Jan. 27, 2011, the entire content of which is hereby incorporated by reference.

### BACKGROUND

The present disclosure relates to an emission intensity measuring device for measuring the emission intensity of a biochip.

In the field of bioscience and so forth, measurement with detection of light emission generated from a “compartmentalized area” is performed. The compartmentalized area is e.g. an area in which a sample is housed separately from other samples, like each well in a biochip in which a large number of wells are arranged in an array manner on one substrate.

In the biochip, a biomolecule such as DNA, protein, or sugar chain, a cell having any of these substances, etc. is immobilized in each well in advance. When a sample including a target molecule is supplied to such a biochip, only the target molecule that is specific to the biomolecule on the biochip (hereinafter, immobilized molecule) binds to the immobilized molecule.

Light emission is caused in the well in which the immobilized molecule and the target molecule bind to each other by a luminescent body binding to the target molecule and the emission intensity is measured. Thereby, the structure and amount of the target molecule included in the sample can be determined. The measurement of the emission intensity is performed by a light receiving element, such as a charge coupled device (CCD) image sensor or a complementary metal oxide semiconductor (CMOS) image sensor, disposed opposed to the biochip. The light emission in the biochip is slight emission in many cases and it is required to accurately measure faint light.

To accurately detect the slight emission, reducing noise generated in the light receiving element will be effective. For example, “biochip kensa souti (biochip examining device, in English)” described in Japanese Patent Laid-open No. 2010-217087 (paragraph [0043]) corrects noise originating in an optical reading device from an image obtained by imaging a biochip.

### SUMMARY

To remove noise generated in the light receiving element, generally light receiving elements that generate large noise are sorted out in advance and the outputs of these light receiving elements are excluded upon detection of light emission. However, particularly in the case of the CMOS image sensor, the distribution of the noise intensity of the light receiving element is continuous and thus it is difficult to sort the pixels into the pixels that are used and the pixels that are not used based on a specific threshold.

The present disclosure has been made in view of the above circumstances. There is provided an emission intensity measuring device capable of reducing the influence of noise generated in a light receiving element in emission intensity measurement.

According to one embodiment of the present disclosure, there is provided an emission intensity measuring device including: a light receiving unit that is disposed opposed to a biochip having a plurality of compartments in which a sample is housed, and includes a plurality of light receiving elements that are arranged; a determining section that determines a weighting rate of each of the light receiving elements based on a noise characteristic of the light receiving element, acquired in advance; a multiplying section that multiplies an output of each of the light receiving elements by the weighting rate to calculate a weighted output of each of the light receiving elements; and an adding section that adds the weighted outputs of the light receiving elements opposed to a respective one of the compartments.

According to this configuration, by the determining section, a low weighting rate is set for the light receiving element having a large noise characteristic and a high weighting rate is set for the light receiving element having a small noise characteristic. Then, the outputs of the respective light receiving elements are multiplied by the set weighting rates by the multiplying section. Therefore, the influence on the measurement result due to the noise characteristic of the light receiving element can be reduced.

The determining section may employ a value proportional to the inverse of the square of the noise intensity of the light receiving element as the weighting rate.

This configuration enables the determining section to determine the weighting rate based on the noise characteristic of the light receiving element, acquired in advance.

The determining section may calculate the weighting rate based on the received-light intensity distribution of the light receiving elements in a light receiving element group composed of the light receiving elements opposed to the same compartment.

In the light receiving element group, distribution often arises in the received-light intensity depending on the positional relationship with the compartment. For example, when light emission is caused in one of the compartments, the received-light intensity of the light receiving element located directly beneath this compartment is higher than that of the light receiving element that is not located directly beneath the compartment. Therefore, by the calculation of the weighting rate based on the received-light intensity distribution of the light receiving elements by the determining section, amplification of noise attributed to the light receiving element having low received-light intensity can be prevented.

The determining section may employ a value proportional to the received-light intensity distribution as the weighting rate.

This configuration enables the determining section to calculate the weighting rate based on the received-light intensity distribution of the light receiving elements.

The determining section may normalize the weighting rate so that each light receiving element group may provide the same output with respect to the same received-light intensity.

This configuration makes it possible to compare the received-light intensity values of the plural light receiving element groups, i.e. the emission intensity values of the respective compartments, with each other.

The light receiving element may be a complementary metal oxide semiconductor image sensor.

In the case of the complementary metal oxide semiconductor (CMOS) image sensor, the noise characteristics of the respective light receiving elements tend to be continuously distributed because of its structure. Therefore, the related-art system in which whether or not the light receiving element is used is determined based on a specific threshold is inadequate, whereas employing one embodiment of the present disclosure is effective.

As described above, one embodiment of the present disclosure can provide an emission intensity measuring device capable of reducing the influence of noise generated in a light receiving element in emission intensity measurement.

Additional features and advantages are described herein, and will be apparent from the following Detailed Description and the figures.

### BRIEF DESCRIPTION OF THE FIGURES

FIG. 1 is a schematic diagram showing an emission intensity measuring device according to one embodiment of the present disclosure;

FIG. 2 is a partially enlarged diagram of the emission intensity measuring device;

FIGS. 3A to 3E is a diagram showing the outline of an ELISA method in which measurement is performed by using the emission intensity measuring device; and

FIG. 4 is a schematic diagram showing the state in which excitation light is irradiated to a biochip of the emission intensity measuring device.

### DETAILED DESCRIPTION

The present disclosure will be described below with reference to the drawings according to an embodiment.

### Configuration of Emission Intensity Measuring Device

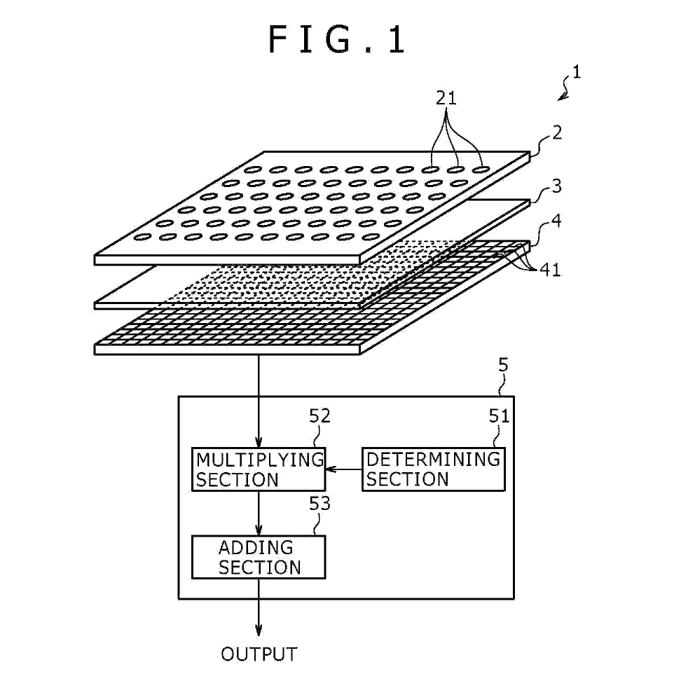

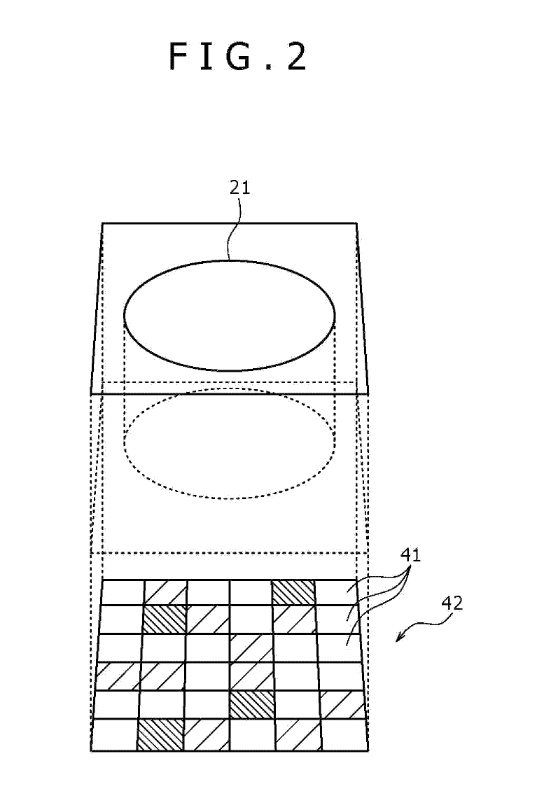

FIG. 1 is a schematic diagram showing the outline of an emission intensity measuring device 1 according to one embodiment of the present disclosure. FIG. 2 is a partially enlarged diagram of the emission intensity measuring device 1. As shown in these diagrams, the emission intensity measuring device 1 has a biochip 2, an excitation light cut filter 3, a light receiving unit 4, and a signal processing device 5. In FIG. 2, the excitation light cut filter 3 is omitted. The biochip 2 and the light receiving unit 4 are opposed to each other by the intermediary of the excitation light cut filter 3 and the light receiving unit 4 is connected to the signal processing device 5. In the present embodiment, the emission intensity measuring device 1 is configured as a device for detecting fluorescence of an antigen. However, it is also possible to employ another configuration as long as the emission intensity measuring device 1 is a device to detect light emission.

The biochip 2 has arranged plural wells 21. Recesses that are so formed as to be compartmentalized from each other can be used as the wells 21 and each well 21 can house a sample independently of the other wells 21. Although the kinds of biochip 2 include deoxyribonucleic acid (DNA) chip, protein chip, sugar chain chip, cell chip, and so forth, the kind of biochip 2 may be any. For example, a biochip in which the length of each one side is several centimeters and the diameter of the well 21 is several tens of micrometers can be used as the biochip 2.

The excitation light cut filter 3 is to block excitation light irradiated to the biochip 2 so that it may be prevented from reaching the light receiving unit 4 and separate the excitation light from fluorescence caused by the irradiation thereof. An arbitrary cut filter may be used as the excitation light cut filter 3.

The light receiving unit 4 has arranged plural light receiving elements 41. The light receiving element 41 is a photoelectric conversion element such as a charge coupled device (CCD) or a complementary metal oxide semiconductor (CMOS). The light receiving unit 4 may be an image sensor in which the light receiving elements 41 are two-dimensionally arranged or may be a line sensor in which the light receiving elements 41 are one-dimensionally arranged. In particular, it is preferable to employ an image sensor that allows easy alignment between the wells 21 and the light receiving elements 41 and is excellent in the fitness between the shape of the well 21 and the shape of the light receiving element 41. The light receiving unit 4 supplies the outputs of the respective light receiving elements 41 to the signal processing device 5. Although the output system differs depending on the element structure of the CCD, CMOS, or the like, the outputs of the respective light receiving elements 41 are output individually for each other.

The light receiving unit 4 is disposed opposed to the biochip 2. Specifically, as shown in FIG. 2, the light receiving unit 4 is so disposed that the plural light receiving elements 41 are opposed to a respective one of the wells 21 of the biochip 2. The group of the light receiving elements 41 opposed to one well 21 is defined as a cluster 42. That is, the light receiving unit 4 has the same number of clusters 42 as that of wells 21.

In the cluster 42, the light receiving elements 41 having various noise characteristics exist. The noise is dark current noise, switching noise, and so forth if the light receiving element 41 is a CMOS element for example. Furthermore, for example the dark current noise is divided into a systematic noise component that is proportional to the time and is predictable and a statistical noise component that has dispersion proportional to the dark current and is unpredictable. Of these noise components, particularly the statistical noise, which cannot be corrected, becomes a problem in emission intensity measurement. The following description is based on the assumption that noise is statistical noise. In FIG. 2, the noise intensity of each light receiving element 41 is exemplified based on the grayscale. In this manner, each cluster 42 includes the light receiving elements 41 having different noise intensity.

The signal processing device 5 executes signal processing to be described later based on the outputs of the respective light receiving elements 41 of the light receiving unit 4. As shown in FIG. 1, the signal processing device 5 has a determining section 51, a multiplying section 52, and an adding section 53. These respective configurations may be realized by a signal processing circuit or may be realized by a program of an arithmetic processing device. The multiplying section 52 is connected to the light receiving unit 4 and the determining section 51 is connected to the multiplying section 52. The adding section 53 is connected to the multiplying section 52 and the output of the adding section 53 is output from the signal processing device 5.

The determining section 51 determines the “weighting rate” of each light receiving element 41. The determining section 51 determines the weighting rate from “statistical noise intensity” of each light receiving element 41, deriving from the intrinsic noise of the light receiving element 41, and “signal sensitivity” deriving from assumed light intensity in the cluster 42, although details of the method for determining the weighting rate by the determining section 51 will be described later. Furthermore, the determining section 51 normalizes the weighting rate according to need so that the received-light intensity can be compared among the clusters 42. The determining section 51 outputs the weighting rates to the multiplying section 52.

The multiplying section 52 multiples the outputs of the respective light receiving elements 41 by the weighting rates output from the determining section 51. Hereinafter, the output of the light receiving element 41 multiplied by the weighting rate will be referred to as “weighted output.” By this multiplication, the outputs of the respective light receiving elements 41 are increased and decreased in accordance with the statistical noise intensity and the signal sensitivity. The multiplying section 52 outputs the weighted outputs to the adding section 53.

The adding section 53 adds the weighted outputs of the respective light receiving elements 41 output from the multiplying section 52 on each cluster 42 basis. Thereby, the received-light intensity in units of the cluster 42 is calculated. The adding section 53 outputs the received-light intensity in units of the cluster 42 from the signal processing device 5.

### Emission Intensity Measuring Method by Use of Emission Intensity Measuring Device

An emission intensity measuring method by use of the emission intensity measuring device 1 will be described. First, the biochip 2 is prepared by the user. Although there are many kinds of emission intensity measuring methods by use of the biochip, the present embodiment can be applied to any of these methods. Here, the enzyme-linked immunosorbent assay (ELISA) method (sandwich method) as one of the methods will be schematically described.

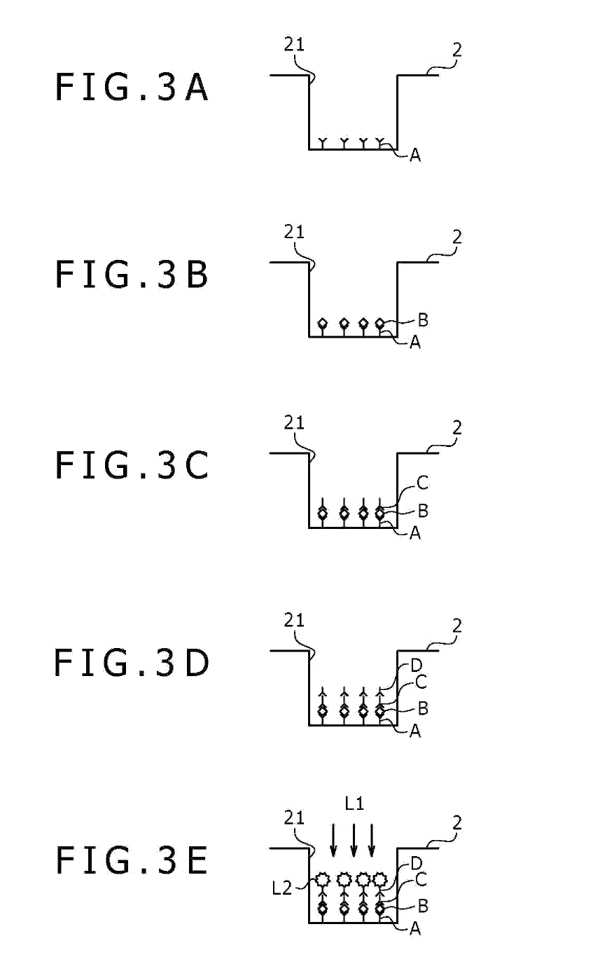

FIG. 3 is a schematic diagram showing the outline of the ELISA method. This diagram schematically shows one well 21 of the biochip 2. As shown in FIG. 3A, an antibody A capable of binding to the protein as the quantification subject (hereinafter, protein of interest) is immobilized to the well 21. At this time, an antibody capable of binding to a protein of interest with a different structure can be immobilized to the other wells 21 for example.

Next, as shown in FIG. 3B, a sample including the protein of interest is supplied to the well 21 and the protein B of interest is bound to the antibody A. Subsequently, as shown in FIG. 3C, a primary antibody C capable of binding to the protein of interest is supplied to the well 21 and the primary antibody C is bound to the protein B of interest. Thereafter, the protein B of interest and the primary antibody C that do not bind are rinsed away.

As shown in FIG. 3D, a secondary antibody D capable of binding to the primary antibody C is supplied to the well 21 and the secondary antibody D is bound to the primary antibody C. The secondary antibody is labeled by a fluorescent molecule. As shown in FIG. 3E, when excitation light is irradiated to the well 21, the fluorescent molecule generates fluorescence. That is, if the intensity of the fluorescence is found about the specific well 21, the quantitative assay of the protein B of interest corresponding to this well 21 is enabled.

In the case of the fluorescence in the ELISA method, the luminescent body is the molecular level and the emission intensity is minute. Therefore, countermeasures such as extension of the exposure time of the light receiving element are taken. However, in this case, noise of the light receiving element becomes a problem. Particularly in such an analysis, the emission intensity is directly linked to the analysis value and therefore accurate emission intensity measurement from which the influence of noise is eliminated should be performed. Such circumstances apply also to emission intensity measuring methods other than the ELISA method.

### Operation of Emission Intensity Measuring Device

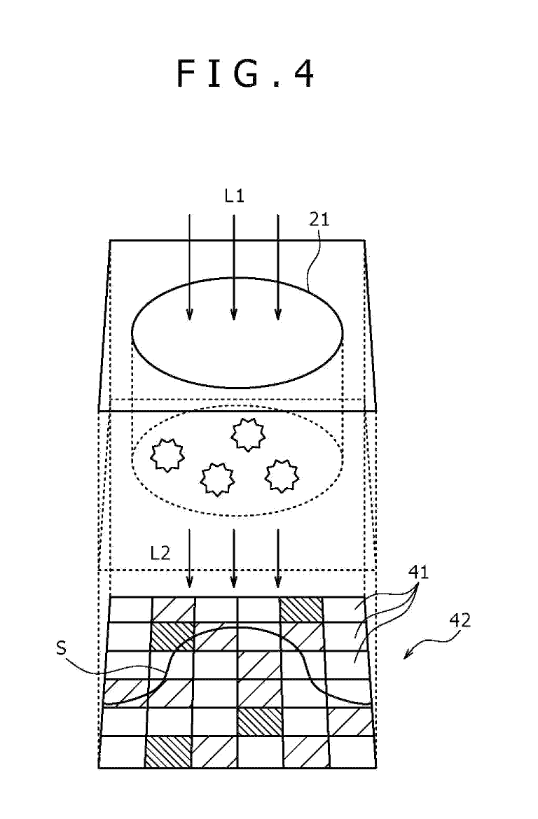

The operation of the emission intensity measuring device 1 will be described. The description is based on the assumption that labeling by a fluorescent molecule is carried out for the biochip 2 of the emission intensity measuring device 1 as described above. FIG. 4 is a schematic diagram showing the state in which excitation light is irradiated to one well 21 of the biochip 2. As shown in this diagram, when excitation light L1 is irradiated to the well 21, fluorescence L2 arises. The fluorescence L2 is transmitted through the excitation light cut filter 3 (not shown in FIG. 4) and is incident on the cluster 42 opposed to this well 21. As shown in FIG. 4, in the light receiving elements 41 of this cluster 42, received-light intensity distribution S is formed depending on the positional relationship with the well 21.

The respective light receiving elements 41 perform photoelectric conversion of the incident fluorescence and output the conversion results to the multiplying section 52. The output of each light receiving element 41 is identified regarding which light receiving element 41 is the source of this output, based on the output order.

The determining section 51 determines the weighting rate. The determining section 51 retains the dark current values measured about the respective light receiving elements 41 before emission intensity measurement. Upon the start of the emission intensity measurement, the determining section 51 obtains the dark current value corresponding to this measurement time and calculates the square root thereof. Furthermore, the determining section 51 adds, to this square root, other kinds of statistical noise such as switching noise as the square root of sum of squares, and employs the addition result as noise intensity Nᵢⱼ of the light receiving element 41. Nᵢⱼ means the noise intensity of the light receiving element 41 on the i-th row and j-th column among the arranged light receiving elements 41 (hereinafter, this applies also to other subscripts).

Furthermore, the determining section 51 retains the received-light intensity distribution S in the cluster 42 obtained by measurement or calculation in advance. The determining section 51 employs it as assumed received-light intensity. Moreover, if there is sensitivity difference among the light receiving elements 41 with respect to the same light intensity, the determining section 51 multiplies the assumed received-light intensity by this sensitivity difference to obtain signal sensitivity Sᵢⱼ.

The determining section 51 calculates weighting rates Rᵢⱼ from the statistical noise intensity Nᵢⱼ and the signal sensitivity Sᵢⱼ. The method for deriving the weighting rate Rᵢⱼ will be described below.

If the noise of each light receiving element 41 has no correlation with the noise of the other light receiving elements 41, the signal/noise (SN) ratio of the light receiving elements 41 configuring the cluster 42 after weighting is given by the equation shown in the following Expression 1.

$$S N ratio = \frac{{\sum }_{i , j} {R}_{ij} {S}_{ij}}{\sqrt{{( {\sum }_{i , j} {R}_{ij} {N}_{ij} )}^{2}}} \qquad Expression 1$$

The weighting rates Rᵢⱼ that minimize this SN ratio are obtained by the equation shown in the following Expression 2.

$${\partial }_{{R}_{ij}} S N ratio = \frac{( {\sum }_{k \neq i , 1 \neq j} {R}_{kl}^{2} {N}_{kl}^{2} ) {S}_{ij} - {N}_{ij}^{2} {R}_{ij} ( {\sum }_{k \neq i , 1 \neq j} {R}_{kl} {S}_{kl} )}{{( {\sum }_{k , l} {R}_{kl}^{2} {N}_{kl}^{2} )}^{3 / 2}} = 0 \qquad Expression 2$$

At this time, the weighting rates Rᵢⱼ are given by the equation shown in the following Expression 3.

$${R}_{ij} = \frac{{S}_{ij} {\sum }_{k \neq i , 1 \neq j} {R}_{kl} {N}_{kl}}{{N}_{ij}^{2} {\sum }_{k \neq i , 1 \neq j} ( {R}_{kl} {S}_{kl} )} \qquad Expression 3$$

In general, the solution of the equation shown in Expression 3 is not analytically obtained. Therefore, an approximation represented by the equation shown in the following Expression 4 is employed.

$$\frac{{\sum }_{k \neq i , i \neq j} {R}_{kl} {N}_{kl}}{{\sum }_{k \neq i , l \neq j} ( {R}_{kl} {S}_{kl} )} = constant \qquad Expression 4$$

This approximation is based on the premise that, whichever specific light receiving element 41 is of the issue, the total sums of RₖₗNₖₗ and (RₖₗSₖₗ) are constant regarding the other light receiving elements 41. This approximation is reasonable if the number of light receiving elements 41 is sufficiently large. Under this approximation, the weighting rate Rᵢⱼ represented by the equation shown in Expression 4 is given by the equation shown in the following Expression 5. It is the most appropriate for the weighting rate Rᵢⱼ to be proportional thereto.

$${R}_{ij} = \frac{{S}_{ij}}{{N}_{ij}^{2}} \qquad Expression 5$$

The signal sensitivity Sᵢⱼ is the sensitivity of the light receiving element 41 to light and at the same time includes the assumed light intensity in the specific light receiving element 41 (probability of that the observed emission phenomenon is detected in the specific light receiving element 41). The noise intensity Nᵢⱼ is noise that does not depend on the detected light intensity. Furthermore, normalization is carried out so that the signal sensitivity Sᵢⱼ may become the same among the clusters 42, and the final weighting rates Rᵢⱼ are given in a form proportional to the equation shown in the following Expression 6. If the received-light intensity is not compared among the clusters 42, the normalization does not necessarily have to be carried out.

$$\frac{{R}_{ij}}{{\sum }_{k , l} ( {R}_{kl} {S}_{kl} )} = \frac{{S}_{ij} {\sum }_{k , l} ( {N}_{kl}^{2} )}{{N}_{ij}^{2} {\sum }_{k , l} ( {S}_{kl}^{2} )} \qquad Expression 6$$

The weighting rates Rᵢⱼ are determined in the above-described manner. By the determining section 51, the low weighting rate Rᵢⱼ is set for the light receiving element 41 having a large noise characteristic and the high weighting rate Rᵢⱼ is set for the light receiving element 41 having a small noise characteristic. Therefore, the influence on the measurement result due to the noise characteristic of the light receiving element 41 can be reduced.

Furthermore, the determining section 51 calculates the weighting rates Rᵢⱼ based on the signal sensitivity Sᵢⱼ associated with the received-light intensity distribution S of the light receiving elements 41, formed depending on the positional relationship with the well 21. This can prevent amplification of noise attributed to the light receiving element 41 having the low received-light intensity.

The determining section 51 outputs the weighting rates Rᵢⱼ calculated in the above-described manner to the multiplying section 52. The multiplying section 52 multiplies the output of each light receiving element 41 by a corresponding one of the weighting rates Rᵢⱼ to generate the weighted outputs.

The adding section 53 adds the weighted outputs of the respective light receiving elements 41. Thereby, the received-light intensity of each cluster 42 is calculated. The received-light intensity of each cluster is output from the signal processing device 5 and quantification and so forth of the substance of interest is performed by the user or an information processing device.

As described above, the emission intensity measuring device 1 determines the weighting rate based on the statistical noise intensity deriving from the intrinsic noise of the light receiving element 41. Thus, the output from the light receiving element 41 having large noise is attenuated and the output from the light receiving element 41 having small noise is amplified. Therefore, the emission intensity measuring device 1 can reduce the influence of the intrinsic noise of the light receiving element 41 in the measurement result. Furthermore, this can reduce the size of the light receiving unit 4.

Specifically, in the emission intensity measuring device 1 according to the present embodiment, if the light receiving element 41 is a CMOS image sensor, noise can be suppressed by 15%. This can reduce the area of the light receiving unit 4 by 25% (1/(noise suppression rate)). In general, the price of the CMOS image sensor is proportional to the area and therefore the cost of emission intensity measurement can be reduced.

Embodiments of the present disclosure are not limited to this embodiment and changes can be made without departing from the gist of the present disclosure.

In the present embodiment, the emission intensity measuring device for measuring the intensity of light emission generated in a biochip has been described. However, embodiments of the present disclosure can be applied also to other measuring devices. Specifically, embodiments of the present disclosure can be applied to a system to detect a phenomenon governed by the same cause-and-effect relationship by plural sensors, such as a system with a pH sensor and a system with a sensor to detect a potential change based on an antigen-antibody reaction.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An emission intensity measuring device comprising:
a light receiving unit configured to be disposed opposed to a biochip having a plurality of compartments in which a sample is housed, and include a plurality of light receiving elements that are arranged;
a determining section configured to determine a weighting rate of each of the light receiving elements based on a noise characteristic of the light receiving element, acquired in advance;
a multiplying section configured to multiply an output of each of the light receiving elements by the weighting rate to calculate a weighted output of each of the light receiving elements; and
an adding section configured to add the weighted outputs of the light receiving elements opposed to a respective one of the compartments.

2. The emission intensity measuring device according to claim 1, wherein the determining section employs a value proportional to an inverse of a square of noise intensity of the light receiving element as the weighting rate.

3. The emission intensity measuring device according to claim 2, wherein the determining section calculates the weighting rate based on received-light intensity distribution of the light receiving elements in a light receiving element group composed of the light receiving elements opposed to the same compartment.

4. The emission intensity measuring device according to claim 3, wherein the determining section employs a value proportional to the received-light intensity distribution as the weighting rate.

5. The emission intensity measuring device according to claim 4, wherein the determining section normalizes the weighting rate so that each light receiving element group provides the same output with respect to the same received-light intensity.

6. The emission intensity measuring device according to claim 5, wherein the light receiving element is a complementary metal oxide semiconductor image sensor.
